(19) United States
(12) Patent Application Publication
(10) Pub. No.: US 2013/0073346 A1
(43) Pub. Date: Mar. 21, 2013

(54) IDENTIFYING COMPANIES MOST CLOSELY RELATED TO A GIVEN COMPANY

(71) Applicants: David Chun, Redwood City, CA (US); Brian Sohmers, Los Altos, CA (US); Andrew Comstock, Menlo Park, CA (US); Nancy Ho, San Jose, CA (US); David Sasaki, Scotts Valley, CA (US)

(72) Inventors: David Chun, Redwood City, CA (US); Brian Sohmers, Los Altos, CA (US); Andrew Comstock, Menlo Park, CA (US); Nancy Ho, San Jose, CA (US); David Sasaki, Scotts Valley, CA (US)

(21) Appl. No.: 13/620,074

(22) Filed: Sep. 14, 2012

Related U.S. Application Data
(60) Provisional application No. 61/535,827, filed on Sep. 16, 2011.

(51) Int. Cl. G06Q 10/00

(52) U.S. Cl. 705/7.39

(57) ABSTRACT

Techniques are provided for determining which entities, in a population of entities, is most like a given entity. In the context of companies, the techniques involve constructing a peer network graph based on company-to-company relationship data. Once the graph is constructed, the weights of the edges are determined, and values for the paths are determined based on the edge weights. Peer connection scores are generated for a particular company based on the number and values of the paths between the node that represents the company and the nodes that represent other companies. Based on the peer connection scores between the particular company and other companies, a subset of the other companies are selected as members of a peer group for the company.

### CROSS-REFERENCE TO RELATED APPLICATIONS; BENEFIT CLAIM

This application claims the benefit of Provisional Appln. 61/535,827, filed Sep. 16, 2011, the entire contents of which is hereby incorporated by reference as if fully set forth herein, under 35 U.S.C. §119(e).

### FIELD OF THE INVENTION

The present invention relates to automatically determining which entities are most similar to other entities and, more specifically, automatically determining the peer groups of companies.

### BACKGROUND

There are numerous reasons why it is important to be able to accurately determine, from a population of entities, which entities are most similar to a given entity. For example, in the context of companies, to accurately evaluate a company's performance during a particular time period, it is helpful to compare how that company performed relative to other similar companies during that same time period.

Unfortunately, the more complex the entity and the larger the population, the more difficult it is to determine which entities are similar to a given entity. For example, determining which companies are most like a given company is particularly difficult given how many companies exist, and how many significant characteristics each company may have.

One way to identify the entities that are similar to an entity is to perform feature-set-to-feature-set comparisons between all of the entities. In this approach, similarity of entities is determined based on similarity of feature sets. This technique is particularly useful when the number of features that characterize an entity is small, and the relative significance of the features is well known. However, feature-set-to-feature-set comparisons do not necessarily produce accurate results for entities, such as companies, where the number of features can be very high and the relative significance of the features is not easy to establish.

For some populations of entities, established classification systems may be used to determine which entities are similar to each other. For example, the Global Industry Classification Standard (GICS) maps companies to 10 sectors, 24 industry groups, 68 industries and 154 sub-industries. Rather than determine similarity of companies based on comparisons between the companies, one may simply assume that all companies that fall into a particular classification are similar to each other. Unfortunately, that assumption may not always hold true.

When the entities involved are companies, yet another approach to finding similar entities would be to simply assume that companies are accurate when they specify which other companies they consider to be their peers. Specifically, under certain regulations, companies are required to disclose which other companies they considered to be their peers. However, the peer disclosures made by companies may be biased. For example, a company may be tempted to identify as its peers, in addition to the most similar companies, one or two badly performing companies. The addition of badly performing companies to a company's peer group makes the company look better by comparison. Because of the potential for bias, it is preferable to identify peers of a company without assuming every single company is made in an unbiased manner.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that illustrates three scenarios where an edge exists between the nodes that represent two companies;

FIG. 2 is a diagram illustrating an example peer network graph;

FIG. 3 is a diagram illustrating directional weights assigned to each type of edge, according to an embodiment of the invention;

FIG. 4 is diagram of final edge weights (directional weight+peer similarity weight) along two particular paths, according to an embodiment of the invention;

FIG. 5 is a flowchart illustrating steps for determining a peer group for a particular company, according to an embodiment of the invention;

FIG. 6 is a block diagram of a computer system upon which embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

As mentioned above, it is often critically important to be able to identify which entities are most similar to a given entity. The process of determining which entities are most similar to a given entity is referred to herein as “peer group selection”. In the context of companies, peer group selection is a critical and highly scrutinized input into executive compensation decisions. Traditional peer group development methods for companies focus on size indicators, such as revenue, and strictly defined industry designations, such as GICS. However, these methods oversimplify the complex and overlapping competitive dynamics that exist in the marketplace.

Techniques are provided herein for identifying the companies that are most closely related to any given company based on properties of a network of disclosed company relationships. In one embodiment, a computer-implemented related-company-identification process takes as input a set of company-to-company relationships (edges) and returns for a given company (node) a ranked list of other companies in the network that are most closely related to the company based on their connectedness in the network.

The network of company-to-company relationships may be extracted from any number of sources. For example, in one embodiment, the company-to-company relationships are extracted from publicly-disclosed compensation benchmarking peer groups reported in SEC filings. The related-company-identification process may also be used on other data sets beyond peer group disclosure, such as company financial competitors or other sets of company-to-company relationship data.

In one embodiment, the related-company-identification process is implemented in machine readable code and takes as input a network of company relationships based on disclosed peer relationships. The related-company-identification process then analyzes the network connections to rank all companies in the network and return a ranked list of most connected companies for any given company. The related-company-identification process may make use of one or several existing algorithms to analyze network connections to optimize the selection of peer companies in the given data set. For example, in one embodiment, the related-company-identification process builds off an existing network link prediction algorithm, such as those described by Katz and Adamic/Adar.

### Related-Company-Identification Process Overview

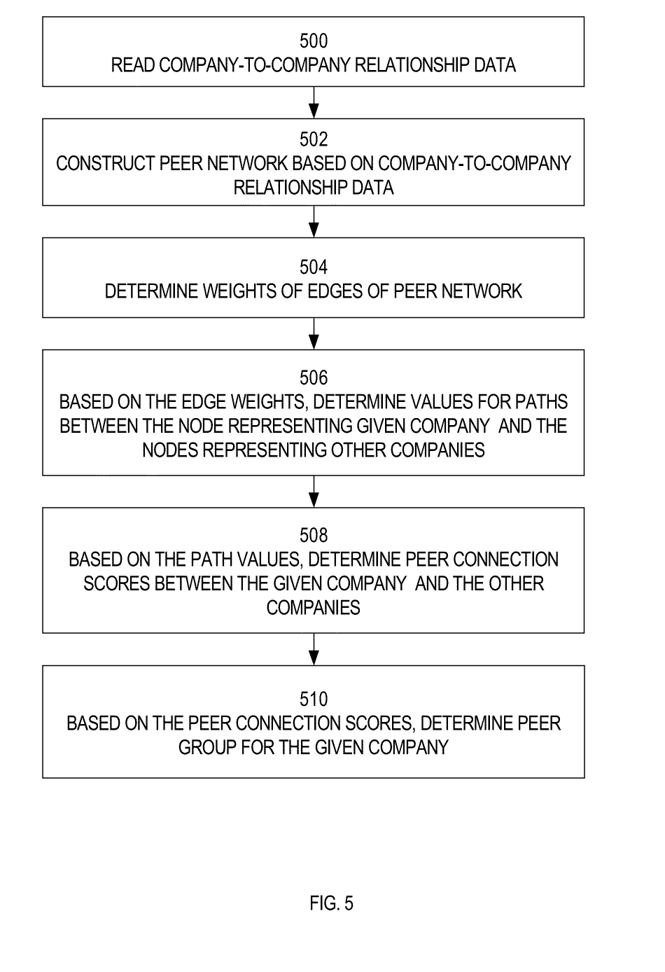

The techniques described herein establish, for each entity in a population, a “peer group” of entities from that population that are most similar to the entity. For the purpose of illustration, it shall be assumed that the entities are companies. Thus, the computer-implemented process for establishing the peer groups is referred to herein as the “related-company-identification process”. The general phases of the related-company-identification process, according to one embodiment, are illustrated in the flowchart of FIG. 5.

Referring to FIG. 5, at step 500 data that identifies relationships between the entities is obtained. In the present example, the entities are companies. Thus, step 500 involves reading data that identifies relationships between companies.

At step 502, a peer network graph is constructed based on the company-to-company relationship data that was obtained in step 500. In the graph, nodes represent companies and the edges between the nodes represent the relationships between the companies.

At step 504, weights are determined for the edges in the peer network. In one embodiment, the weights take into account factors such as the direction of the relationship. For example, the weight of an edge between A to B may be higher if it runs both from A to B and from B to A, rather than simply in one direction.

At step 506, values for paths are determined based, at least in part, on the edge weights and path lengths. In general, the longer the path, the lower the value of the path.

At step 508, peer connection scores between the given company and other companies are determined based on the path values, and the number of paths, between the given company and the other companies. In general, the more paths between a given company and another company, and the shorter the distance of the paths, the higher the peer connection score between the given company and that other company.

Finally, at step 510, peer groups for the given company are determined based on the peer connection scores determined in step 508. The companies that are selected to be in the peer group of the given company are those deemed to be most similar to the given company. In particular, the higher the connection score from a particular company to another company, the more similar, to the particular company, the other company is considered to be.

Each of these phases shall be described in greater detail hereafter.

### Company-to-Company Relationships

As mentioned above, peer group selection is performed automatically based, at least in part, on a network graph where the nodes represent entities, and the edges represent relationships between the entities. In the context of companies, the company-to-company relationship information from which such a network graph is constructed may come from any number of sources.

For the purpose of explanation, an embodiment shall be described in which the network graph is generated based on company-to-company relationship information obtained from publicly available sources. More specifically, an embodiment shall be described in which the network graph is based on the disclosed peer groups reported by companies in their SEC filings. This information may be obtained, for example, by gathering the most recent reported peer group each year for all companies in the Russell 3000.

This data is used to construct the actual network of peer connections that currently exists for public companies. The related-company-identification process analyzes this existing network to identify strong and weak connections between two companies in the network.

### Bias Reduction/Elimination

As mentioned above, a company's reported peer groups may reflect a bias. In particular, a company's reported peer groups may include “false peers” that are identified by the company as peers for a reason other than similarity (e.g. because they performed badly or that they pay their executives highly). However, a network built on the reported peer group information of a population of companies will tend to reduce or eliminate the biases inherent in the reports of the individual companies. Specifically, the connectivity of a company with its actual peers will be significantly stronger than the connectivity of the company with its false peers.

For example, assume that company B is an actual peer of company A, and company C is a false peer of company A. Under these circumstances, the connectivity between the nodes representing companies A and B in the graph may be strong based on:
company A identifying company B as a peer
company B identifying company A as a peer,
reported peers of company A identifying company B as a peer, and
reported peers of company B identifying company A as a peer.

In contrast, the connectivity between the nodes representing companies A and C would be weak, because:
company C is unlikely to identify company A as a peer,
reported peers of company A are not likely to identify company C as a peer, and
reported peers of company C are not likely to identify company A as a peer.

Thus, while company A reported company C as a peer, peer groups established based on connectivity between nodes in the graph of company relationships would be more likely to establish company B, but not company C, as a peer of company A.

### The Peer Network Graph

As mentioned above, company-to-company relationship information is used to form a network graph in which companies are represented by nodes, and relationships between companies are represented by edges. A network graph thus constructed is referred to herein as a “peer network graph”. For example, if company A discloses fifteen peers then there will be fifteen edges from A, one to each of the disclosed peers.

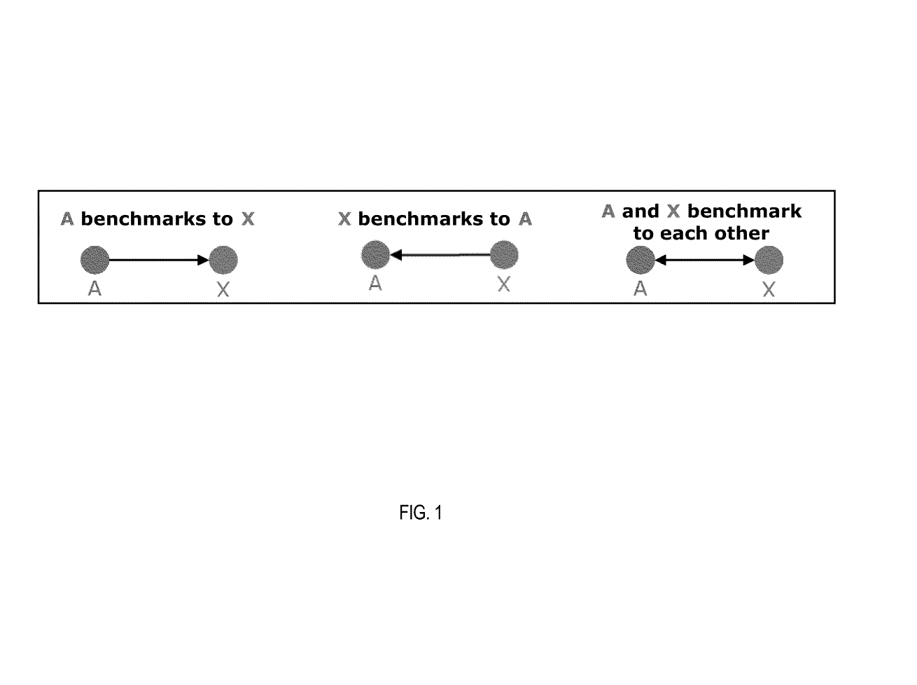

According to one embodiment, the edges of the peer graph are directional, unlike traditional social networks. For example, company A might benchmark to company X, but company X might not benchmark to company A. FIG. 1 is a block diagram that illustrates three scenarios where an edge exists between the node that corresponds to company A (“node A”) and the node that corresponds to company X (“node X”).

Specifically, if company A benchmarks to company X, but company X does not benchmark to company A, then the graph contains a unidirectional edge from the node A to node X. Conversely, if company X benchmarks company A, but company A does not benchmark company X, then the graph contains a unidirectional edge from the node X to node A. If company X benchmarks company A and company A benchmarks company X, then the edge between node A and node X is bidirectional.

In aggregate, the peer network represents all peer group decisions made by the market. As a specific example, a peer network constructed from the company-to-company relationship information obtained from the Russell 3000 contains approximately 3,000 nodes and 33,000 edges. By analyzing this data, the validity of any peer group or identify potential peers can be assessed.

The related-company-identification process described hereafter uses the peer network graph to identify the strength of relationships between two companies. By looking directly at market data, a graph-based approach avoids the limitations of arbitrary financial cut-offs or discrete industry groupings and better represents the complex relationships that exist in a competitive marketplace.

### Example Peer Network

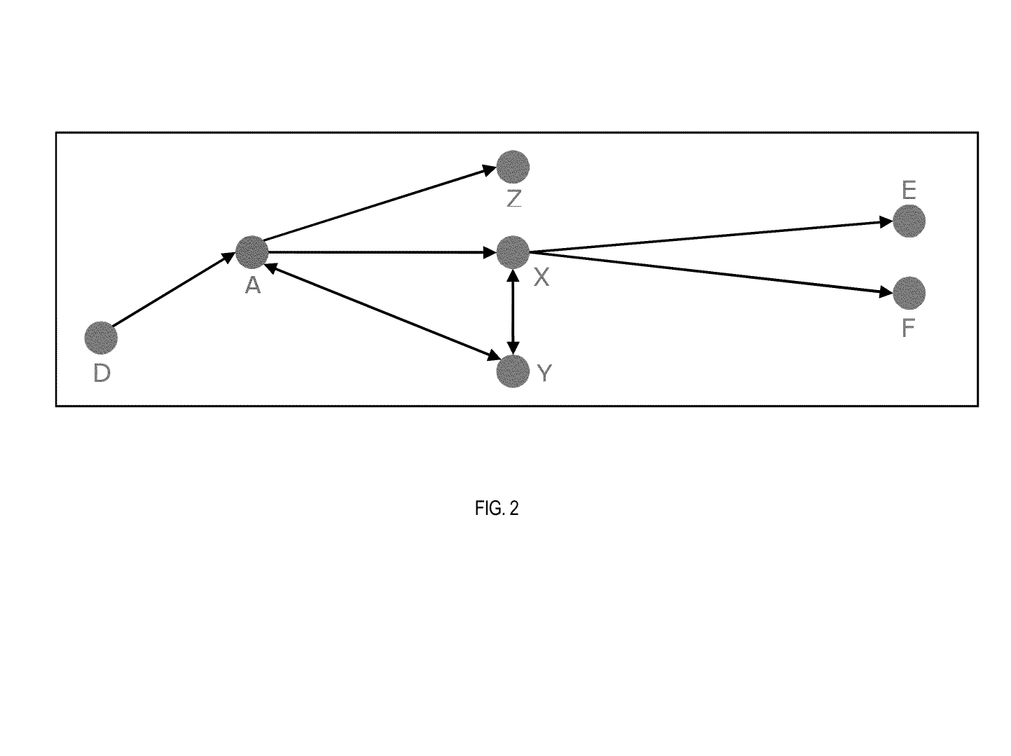

The size of a peer network is based on the number of entities in the population for which the analysis is being performed, as well as the number of relationships that exist between them. As mentioned above, when the population is the companies of the Russell 3000, the peer network can be extremely large. For the purpose of illustration, the smaller peer network illustrated in FIG. 2 will be discussed. However, the techniques described herein are not limited to any particular size of peer network, nor any particular type of entity or relationship.

Referring to FIG. 2, node A corresponds to company A, which is the company whose peer group will be constructed in the example. As illustrated in FIG. 2, company A has a disclosed peer group of three companies, X, Y, and Z. Companies X and Y benchmark to each other, and company Y also benchmarks to company A. Company D is a company that benchmarks to company A, but company A does not benchmark to company D. Company X has two additional peers that are not connected to company A, called company E and company F.

### Strength-of-Connection Factors

According to one embodiment, the related-company-identification process considers four separate factors to determine the strength of the connection between two companies, two of which relate to edge value and two of which relate to path value. Specifically, edge value relates to how similar any two neighboring companies in the network. The factors that affect edge value include:
Direction of peer relationship
Similarity between peer groups

Path value relates to how tightly connected are two companies in the peer network. The factors that relate to paths include:
Number of paths
Distance of each path

How these factors may be used in determining peer groupings shall be described in greater detail below.

### Determining the Weight of an Edge

According to one embodiment, the first step of the related-company-identification process is to weight the value of each edge. Not all peer connections are equal, and the two factors considered here help identify stronger peer connections. As mentioned above, the first factor to weighting the edge is the direction of the edge. The related-company-identification process considers three types of connections: outgoing, incoming, and reciprocal. Assuming the process starts at company A, an outgoing connection is all of A's peers (X, Y, and Z). An incoming connection is any company that considers A a peer but A does not consider them a peer (D). Finally, the strongest connection is a reciprocal connection where A and another company both consider each other as peers (A and Y, X and Y).

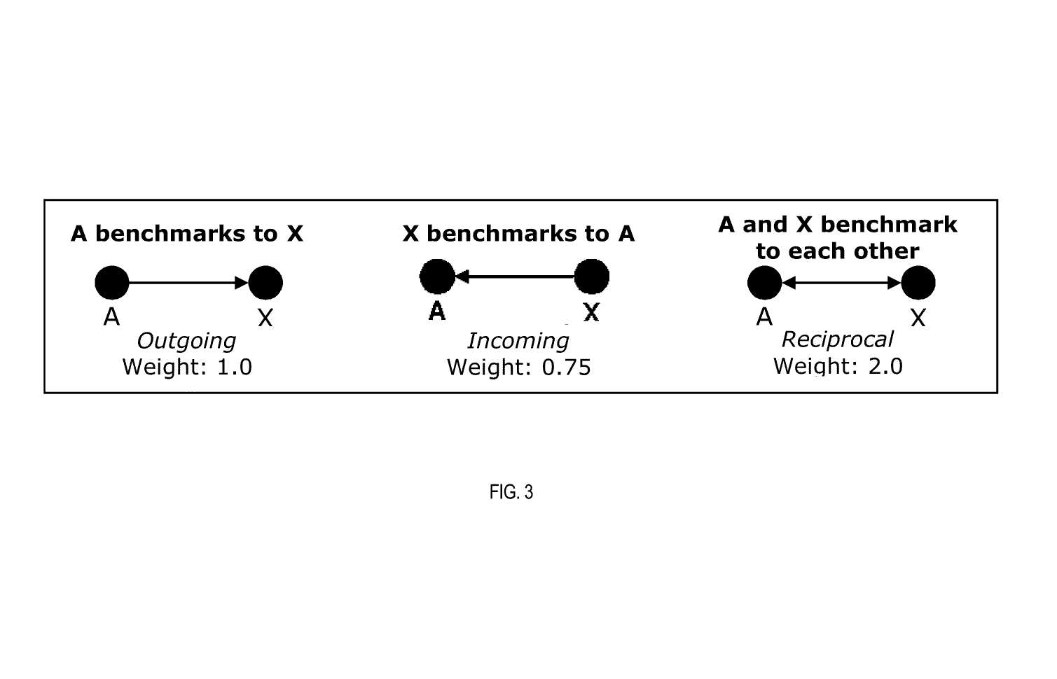

Reciprocal connections carry the most weight because both companies validate that the other represents a good benchmarking candidate. Note that the weight of the connection from A to X is different from the weight from X to A (since A to X is outgoing and X to A is incoming). In one embodiment, outgoing edges are weighted at half the strength of reciprocal edges, and at 33% more strength than incoming edges. This makes a company's own peer choices more influential than the decisions of other companies in the network. FIG. 3 is a block diagram that illustrates the weights assigned to each type of edge, according to an embodiment of the invention.

The edge weights illustrated in FIG. 3 are merely examples to illustrate how different types of edges may be weighted. The exact weight given to each type of edge may vary from implementation to implementation, and the techniques described herein are not limited to any particular type of edge weighting scheme.

### Peer Group Similarity

In addition to assigning weights based on the type of peer relationship, the related-company-identification process may also attempt to determine how strong a relationship is based on peer group similarity. The assumption is that companies which share many of the same peers have a stronger connection.

According to one embodiment, existing network algorithms that weight “less popular” connections more strongly may be used as part of the peer group similarity calculation. Such network algorithms include, for example, Adamic/Adar and SimRank, which both attempt to quantify the value of a connection between two nodes based on the similarity of their connections, weighting the less common connections more heavily.

The Adamic/Adar technique is described in “Lada A. Adamic and Eytan Adar. Friends and neighbors on the web. Social Networks, 25(3):211-230, July 2003”, the content of which is incorporated herein by reference. The SimRank technique is described in “G. Jeh and J Widom. SimRank: a measure of structural-context similarity. In KDD'02: Proceedings of the eighth ACM SIGKDD international conference on Knowledge discovery and data mining, pages 538-543, ACM Press 2002”, the content of which is incorporated herein by reference. These are merely two examples of the various network analysis algorithms that may be used by the techniques described herein, and those techniques are not limited to any particular network analysis algorithm.

In an alternative embodiment, a simpler mechanism may be used to account for peer group similarity, such as the Jaccard coefficient. The Jaccard coefficient is equal to the number of shared peers divided by the total number of peers for both companies added together. In a related embodiment, the related-company-identification process uses a modified Jaccard coefficient, which is equal to the number of shared peers divided by the number of peers of the potential peer company.

In the modified Jaccard coefficient, the potential peer controls the final value. Since related-company-identification process is comparing many potential peers using a single focus company, using the basic Jaccard formula could cause the focus company peer number to dominate and dilute the differences between the different potential peers. For example, if the focus company had 200 peers and each potential peer had between 10-30 peers, using the standard Jaccard coefficient would show almost no difference between the potential peer with 10 peers and the potential peer with 30 peers.

In an embodiment that uses the modified Jaccard coefficient, the related-company-identification process calculates peer group similarity by counting the number of shared connections and dividing this by the number of total connections for the potential peer company. The result is a value between 0 and 1 that indicates the percent of shared peers between the companies. If the value is high, that indicates that a large percentage of peers are shared between two companies and, therefore, that they are more closely connected. This also helps to control for varying sizes of peer groups.

Referring to the peer network illustrated in FIG. 2, the edge from A to X would have a peer similarity weight of 2/4 because A shares 2 connections with X and X has 4 total connections. This calculation is detailed below along with a table comparing the peers of A and X:

| A's Connections | X's Connections |
|---|---|
| X | A |
| Y | Y |
| Z | E |
| D | F |

Weight of edge from A to X
= # shared connections of A and X/# X's connections
= A and X share 2 connections/X has 4 connections
= 2/4 = 0.5

According to one embodiment, when counting the number of shared connections and total connections, the related-company-identification process counts any connection, including an incoming connection, to a company. For example, since A considers X to be a peer (but not vice versa), A is considered a “connection” of X even if the line does not go in that direction. Note this is different than the concept of a “peer” because a “connection” includes any direct connection at all to that company. Additionally, in one embodiment, the related-company-identification process adds 1 (one) to both the numerator and denominator to account for the connection between the two companies being considered. For example, Since X is one of A's peers, it counts as a “shared peer” for the purposes of the calculation above.

This ratio is multiplied by the directional weighting described above to obtain a final edge weighting:

Final Edge Weight for A to X:

| | |
|---|---|
| 1.0 × 0.5 = | 0.5 |
| Directional Weight × Peer Similarity Weight = | Final Edge Weight from A to X |

### Path Analysis

After computing the final edge weighting for every edge in the network, the related-company-identification process focuses on the paths between two companies. Note that each edge has two directions (from A to X and from X to A are different directions). In one embodiment, the weighting that will be used by the related-company-identification process depends on the direction that the edge is crossed (A to X will have a different value than X to A).

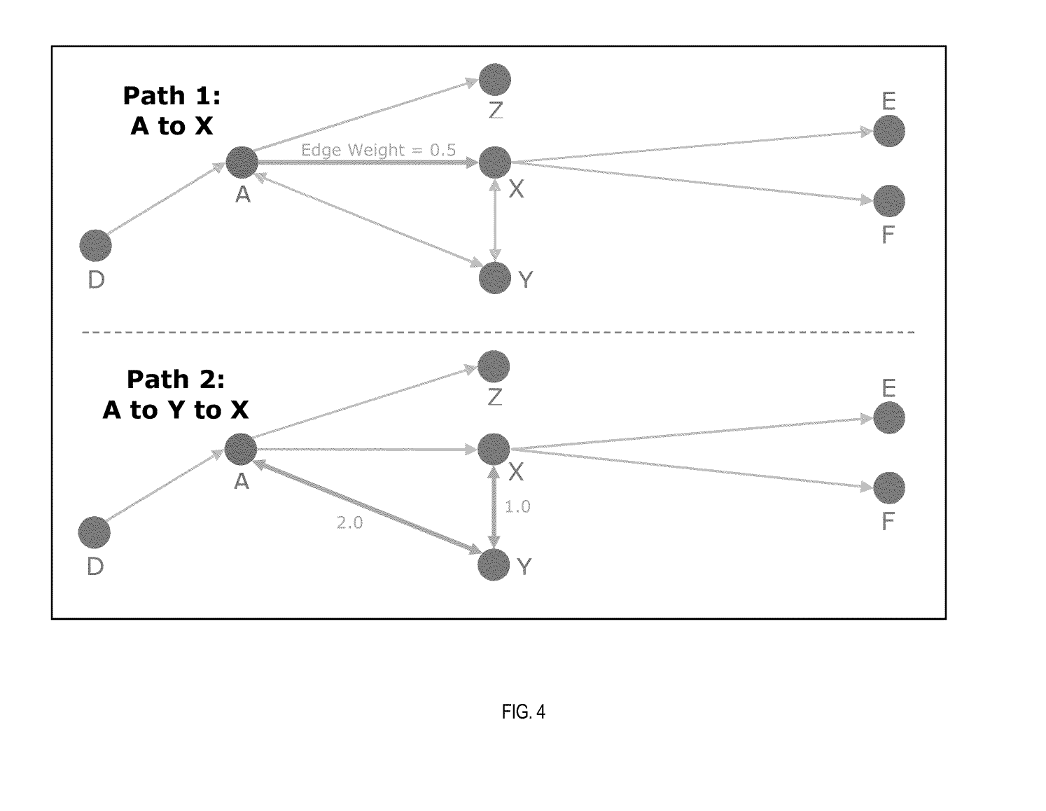

As used herein, a “path” is any route through the network from one company to another company across existing edges. Most companies will have multiple paths between them of varying distances. For example, one path from A to X is a direct path (distance=1) but another path would be A to Y to X (distance=2). These two paths between A and X, and the weights that belong to their edges, are illustrated in FIG. 4.

The total number of paths there are between two companies is an indication of their connectedness. In order for two companies to have many paths between them, other companies in the peer network must have validated that the two companies are relevant peers. In other words, the more times these two companies appear in other peer groups, the more likely that they will have many paths between them. Note that this is also controlled by the peer group similarity formula above, in order to avoid overweighting companies with large disclosed peer groups.

According to one embodiment, the value of each path is equal to the average edge weight along the path. In one embodiment, this value is adjusted based on the distance of the path, so that shorter paths (those that cross fewer edges) have a higher value. For example, a direct connection will have a higher value than a connection through another peer. To accomplish this, the related-company-identification process applies a network analytics formula, such as that referred to as the Katz algorithm, which proportionally reduces the value of paths of distance 2 and greater. The Katz algorithm is described in Leo Katz, “A New Status Index Derived from Sociometric Analysis.” Psychometrika, March 1953, the contents of which are incorporated herein by reference.

In general, the Katz algorithm sums up the total number of paths between any two nodes in a network, weighting shorter paths more highly based on a constant attenuation factor. The amount of reduction applied to longer paths is set based on a constant called an attenuation factor, typically set between 0.005 and 0.05. In one embodiment, the related-company-identification process uses an attenuation factor of 0.04 based on back-testing across existing peer market data.

In one embodiment, a specialized version of the Katz algorithm, called “weighted Katz”, is used because each path has a weighting equal to the average edge weight of the path. Therefore not all paths of the same length have the same value. Thus, the weight of a path will depend on the weightings calculated using the methods described above, as well as the distance of the path.

The weights of the two paths connecting A and X will thus be calculated as follows:

Path 1: A to X

| | |
|---|---|
| 0.04¹ × 0.5 = | 0.02 |
| Distance Factor^{Distance} × Average Edge Weight (A to X) = | Path Value |

Path 2: A to Y to X
First, calculate edge weights for A to Y and Y to X:

| | |
|---|---|
| 2.0 × 1.0 = | 2.0 (A to Y) |
| 2.0 × 0.5 = | 1.0 (Y to X) |
| Directional Weight × Peer Similarity Weight = | Final Edge Weight |

Then, using these edge weights, calculate
the path value through these 2 edges:

| | |
|---|---|
| 0.04² × (2.0 + 1.0)/2 = | 0.0024 |
| Distance Factor^{Distance} × Average Edge Weight(A to Y + Y to X)/2 = | Path Value |

### Generating Peer Connection Scores

After computing the value of each path using the average edge weights and the Katz attenuation factor, the raw peer connection score can be calculated. In one embodiment, the raw peer score is computed by summing together the path value for all paths from one company to another of distance less than 4. This computation is then repeated for every set of two companies in the network, to calculate a connection score from each company to each other company. These raw scores can then be compared to identify the strongest connections to any given company.

For example, the raw peer score from A to X would be computed as follows:

Raw Peer Score from A to X
= Sum of all Paths from A to X
= Value of Path 1 (0.02) + Value of Path 2 (0.0024)
= 0.0224

In our example peer network, A and Y would have the strongest connection because they benchmark to each other and other companies in A's peer group also benchmark to Y. D would have be the weakest peer connection score relative to A because it has only 1 incoming connection to A and no shared peers.

### Constructing Peer Groups Based on Peer Connection Scores

After determining the raw peer score between each company and each other company in the population, the peer group for any given company may be determined by selecting the top peers based on the raw score. In one embodiment, the related-company-identification process simply selects the top 15 potential peers with the highest raw score as the constructed peer group. In this embodiment, 15 was chosen because it is the most common number of peers for companies in the S&P 1500 and it is very close to the median number of peers of 16. However, the related-company-identification process may alternatively select any number of peers for a company's peer group. For example, a given company's peer group may be established by selecting the top 30 companies that have the highest raw peer connection score relative to the given company.

In one embodiment, the related-company-identification process allows for variable number of peers to be selected based on their raw score and the differences in raw score between potential peers. For example, if there is a large gap between company 12 and 13 in raw score, the related-company-identification process could stop at company 12 and call that the final constructed peer group.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

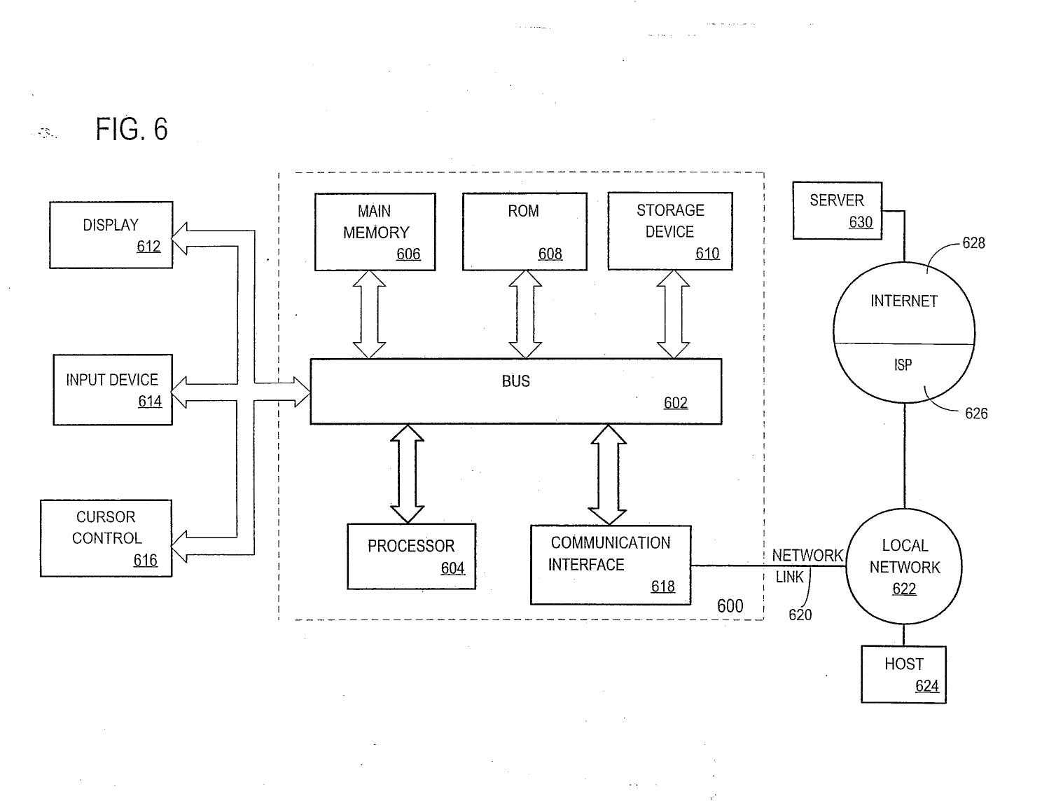

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
constructing a peer network graph based on company-to-company relationship data, wherein the peer network graph includes nodes that correspond to companies, and edges that represent relationships between companies;
determining weights of the edges in the peer network graph;
wherein the peer network graph includes a particular node that represents a particular company, and a node for each of a plurality of other companies;
generating a peer connection score between the particular company and each company of the plurality of other companies by performing the following steps for each company of the plurality of other companies:
based on the weights of the edges, determining values for paths between the particular node and the node that represents the other company; and
based on the values of the paths between the particular node and the node that represents the other company, generating the peer connection score between the particular company and the other company;
based on the peer connection scores between the particular company and the plurality of other companies, selecting a subset of said plurality of other companies as members of a peer group for the particular company;
wherein the method is performed by one or more computing devices.

2. The method of claim 1 wherein the company-to-company relationship data includes data about peer groups publicly disclosed by the particular company and the plurality of other companies.

3. The method of claim 1 wherein the company-to-company relationship data includes data obtained from SEC filings of the particular company and the plurality of other companies.

4. The method of claim 1 wherein determining weights of the edges includes determining weights of the edges based, at least in part, on a direction of the relationship represented by the edges.

5. The method of claim 4 where reciprocal edges are given more weight than unidirectional edges.

6. The method of claim 4 wherein the weight determined for a particular edge is based, at least in part, on a directional weight determined for the particular edge and a peer similarity weight determined for the particular edge.

7. The method of claim 1 wherein:
a particular path exists between the particular node and a second node that represents a second company; and
the value for the particular path is based, at least in part, on the distance of the particular path and the weights assigned to the edges that belong to the particular path.

8. The method of claim 1 wherein selecting a subset includes selecting N companies that have the highest peer connection scores relative to the particular company.

9. The method of claim 8 further comprising automatically selecting N based, at least in part, on the size of gaps between peer connection scores.

10. The method of claim 1 wherein the peer connection score between the particular company and a second company is based, at least in part, on the number of paths between the particular node and the node that represents the second company, and the values of the paths between the particular node and the node that represents the second company.

11. A non-transitory computer-readable medium storing instructions which, when executed by a processor, causes performance of a method comprising the steps of:
constructing a peer network graph based on company-to-company relationship data, wherein the peer network graph includes nodes that correspond to companies, and edges that represent relationships between companies;
determining weights of the edges in the peer network graph;
wherein the peer network graph includes a particular node that represents a particular company, and a node for each of a plurality of other companies;
generating a peer connection score between the particular company and each company of the plurality of other companies by performing the following steps for each company of the plurality of other companies:
based on the weights of the edges, determining values for paths between the particular node and the node that represents the other company; and
based on the values of the paths between the particular node and the node that represents the other company, generating the peer connection score between the particular company and the other company;
based on the peer connection scores between the particular company and the plurality of other companies, selecting a subset of said plurality of other companies as members of a peer group for the particular company;
wherein the method is performed by one or more computing devices.

12. The non-transitory computer-readable medium of claim 11 wherein the company-to-company relationship data includes data about peer groups publicly disclosed by the particular company and the plurality of other companies.

13. The non-transitory computer-readable medium of claim 11 wherein the company-to-company relationship data includes data obtained from SEC filings of the particular company and the plurality of other companies.

14. The non-transitory computer-readable medium of claim 11 wherein determining weights of the edges includes determining weights of the edges based, at least in part, on a direction of the relationship represented by the edges.

15. The non-transitory computer-readable medium of claim 14 where reciprocal edges are given more weight than unidirectional edges.

16. The non-transitory computer-readable medium of claim 14 wherein the weight determined for a particular edge is based, at least in part, on a directional weight determined for the particular edge and a peer similarity weight determined for the particular edge.

17. The non-transitory computer-readable medium of claim 11 wherein:
a particular path exists between the particular node and a second node that represents a second company; and
the value for the particular path is based, at least in part, on the distance of the particular path and the weights assigned to the edges that belong to the particular path.

18. The non-transitory computer-readable medium of claim 11 wherein selecting a subset includes selecting N companies that have the highest peer connection scores relative to the particular company.

19. The non-transitory computer-readable medium of claim 18 further comprising automatically selecting N based, at least in part, on the size of gaps between peer connection scores.

20. The non-transitory computer-readable medium of claim 11 wherein the peer connection score between the particular company and a second company is based, at least in part, on the number of paths between the particular node and the node that represents the second company, and the values of the paths between the particular node and the node that represents the second company.

21. A computer system comprising:
a processor;
memory coupled to the processor;
a non-transitory computer-readable medium, operatively coupled to the memory, storing instructions which, when executed by the processor, causes performance of a method comprising the steps of:
constructing a peer network graph based on company-to-company relationship data, wherein the peer network graph includes nodes that correspond to companies, and edges that represent relationships between companies;
determining weights of the edges in the peer network graph;
wherein the peer network graph includes a particular node that represents a particular company, and a node for each of a plurality of other companies;
generating a peer connection score between the particular company and each company of the plurality of other companies by performing the following steps for each company of the plurality of other companies:
based on the weights of the edges, determining values for paths between the particular node and the node that represents the other company; and
based on the values of the paths between the particular node and the node that represents the other company, generating the peer connection score between the particular company and the other company;
based on the peer connection scores between the particular company and the plurality of other companies, selecting a subset of said plurality of other companies as members of a peer group for the particular company.
